(19) United States
(12) Patent Application Publication
(10) Pub. No.: US 2015/0021454 A1
(43) Pub. Date: Jan. 22, 2015

(54) Autonomous Remote Anchor System

(71) Applicant: Itzhak Sapir, Irvine, CA (US)

(72) Inventor: Itzhak Sapir, Irvine, CA (US)

(21) Appl. No.: 13/796,009

(22) Filed: Mar. 12, 2013

(51) Int. Cl. F16M 13/00

(52) U.S. Cl. CPC F16M 13/00
USPC 248/545

(57) ABSTRACT

An autonomous remote anchor system for providing an anchor connector to a surface, such as a ground anchor for an unattended ground sensor is disclosed. An inflatable positioning structure is inflated and configured to orient an anchor assembly in a vertical orientation with respect to the ground or surface upon which it is disposed. Upon vertical orientation, an actuator in the anchor assembly, such as a voice coil, is energized and drives a hammer element that is slideably disposed in the housing, striking the upper surface of the anchor. The drive cycle is repeated, driving it into the surface until the depth of penetration is sensed by a load sensing element.

### CROSS-REFERENCE TO RELATED APPLICATIONS

This application claims the benefit of U.S. Provisional Patent Application No. 61/613,543, filed on Mar. 21, 2012 entitled “Autonomous Remote Anchor System” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of anchoring systems. More specifically, the invention relates to an autonomous remote ground anchoring system for use with a device such as an unattended ground sensor for the anchoring and orientation of an antenna structure.

2. Description of the Related Art

In military, ground surveying, environmental monitoring, wildlife monitoring and other applications, there is a need to deploy unattended sensors in locations where it is difficult or impossible to have human personnel place and secure the sensor suite in the desired orientation.

In these applications, the sensors may be dropped from the air or launched into the desired location. In these scenarios, there is a need for an anchoring and orientation system that brings the sensor suite to the correct orientation and firmly anchors it to the ground in a completely autonomous manner. There is also a need to have the ability to place a remote anchor with a tether or tagline attached to it that supports and anchors a structure such as an antenna tower.

Prior art “weeble-like” systems are used to place unattended sensor systems in an upright orientation but they don't provide any ground anchoring means. Anchor systems with orientation sensors and mechanical manipulators for re-orienting the sensor suite are also in the prior but again, without anchoring means.

The device of the invention provides a solution for both the orientation and anchoring of an unattended sensor system. It desirably pre-loads the anchor system to confirm secure anchoring. No such solution is known to be used in the prior art.

### BRIEF SUMMARY OF THE INVENTION

An autonomous remote anchor system for providing an anchor location on a surface, such as a ground anchor for an unattended ground sensor is disclosed.

An inflatable positioning structure is inflated and configured to orient an anchor assembly in a vertical orientation with respect to the ground or surface upon which it is disposed. Upon vertical orientation, an actuator in the anchor assembly, such as a voice coil, is energized and upwardly drives a hammer element that is slideably disposed in a volume in the housing. The actuator drive is reversed at the top of the stroke and the hammer reverses its travel direction, striking the upper surface of the anchor. The drive cycle is repeated, driving it into the surface until the depth of penetration is sensed by a load sensing element.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts a preferred embodiment of the invention after inflation of the positioning structure.

FIGS. 2A, 2B and 2C depict a preferred embodiment of the anchor assembly of the invention, illustrating certain major elements thereof.

FIG. 3 depicts the anchoring system of the invention retained within a separable enclosure prior to inflation.

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

Turning now to the figures wherein like numerals define like elements among the several views, an autonomous or self-anchoring system is disclosed.

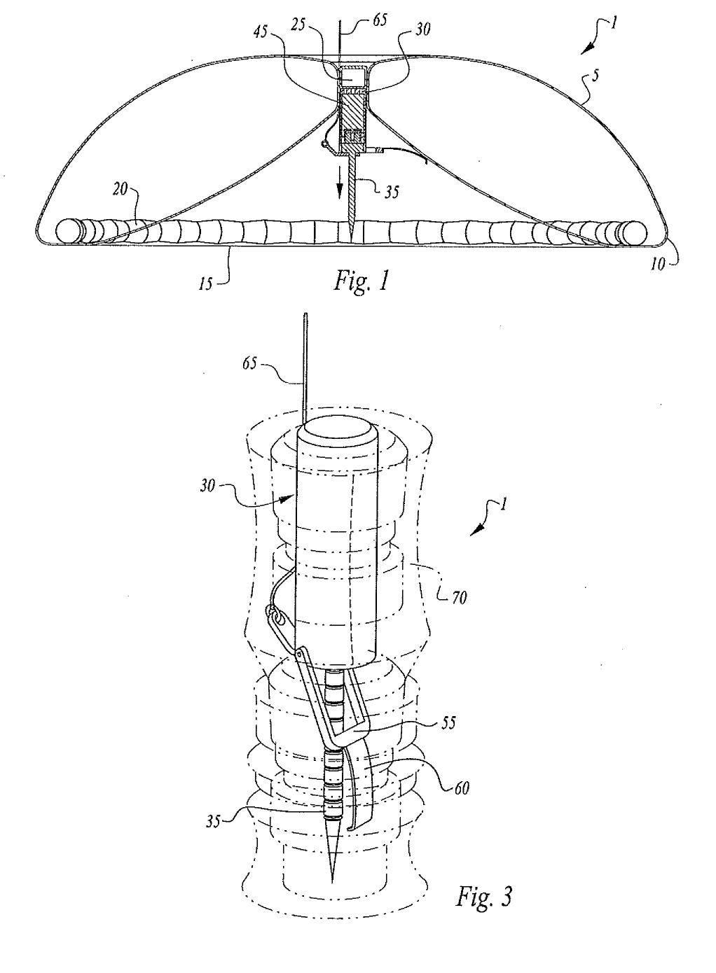

A preferred embodiment of the invention is shown in FIG. 1, depicting an autonomous anchoring system 1.

Anchoring system 1 may comprise an inflatable positioning structure 5 comprising a base perimeter 10 which in turn defines a base surface area 15.

Positioning structure 5 may desirably be fabricated from a thin, lightweight fabric material such as nylon or polyester fabric or from an elastomer or plastic material or any material having suitable physical and mechanical properties for the intended environment and application of the anchor system.

A weighting element 20 is disposed proximal and along or about least a portion of base perimeter 10. Weighting element 20 may comprise a weighted chain or length of weighted elements disposed along base perimeter 10 of positioning structure 5 and serves to properly orient system 1 on the surface upon which it is disposed during and after the inflation phase of positioning structure 5.

The illustrated preferred embodiment may further comprise an inflating element 25 that when activated, provides an inflation source for inflating position structure 5. Any suitable gas inflation source may be used such as a compressed gas element, chemical reaction inflation source or powered air pump means.

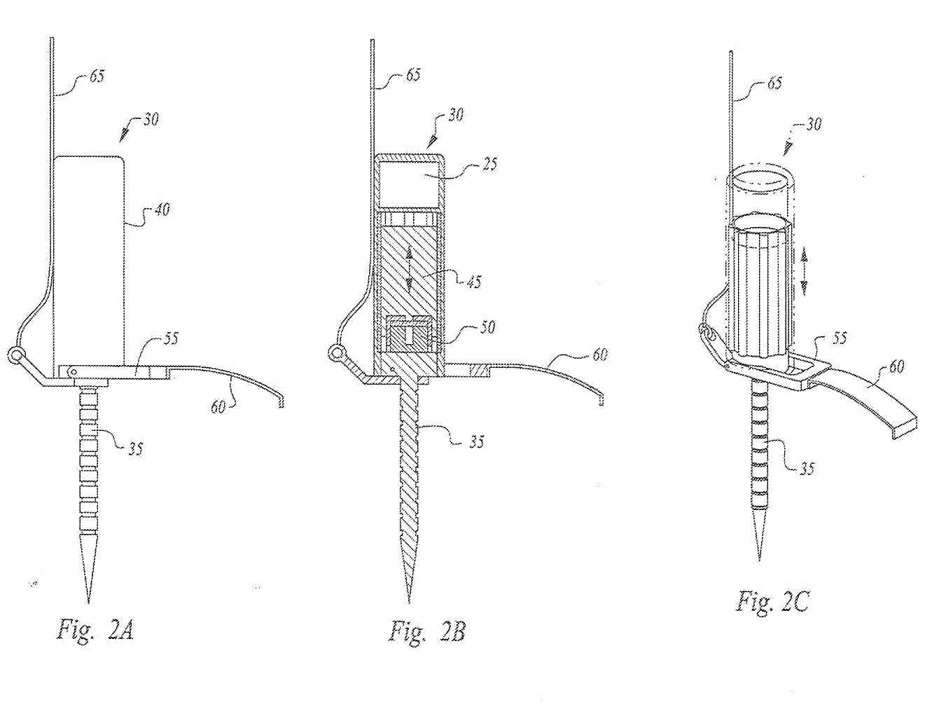

As best illustrated in FIGS. 2A, 2B and 2C, the invention further may further comprise an anchoring assembly 30. Anchoring assembly 30 may comprise an anchor 35, a housing 40, and a hammer element 45.

Hammer element 45 may be oscillatably disposed in a volume defined within housing 40. Anchor 35 is preferably provided as a metal stake or pin structure suitable for penetrating the desired surface such as sand, or soft or rocky soil. A titanium or tungsten anchor element material is well-suited for certain ground or soil-based applications.

The system of the invention may further comprise an actuator 50 such as an electromagnetic actuator that is configured to drive or urge hammer element 45 in a first stroke direction and second stroke direction in the volume much like a piston is driven in a cylinder volume (e.g., upwardly and downwardly with respect to the ground surface).

Anchor 35 and hammer element 45 are configured whereby the upward and downward oscillation of hammer element 45 being driven by actuator 50 within the volume in a second stroke direction (e.g., downwardly with respect to the ground surface) strikes and urges anchor 35 in the second stroke direction.

Actuator 50 may be comprised of an electronic voice coil of suitable specifications for driving hammer element 45 in response to current passing through the windings of the coil thereof.

In operation, positioning structure 5 and anchoring assembly 30 are configured and cooperate with each other whereby an inflation of positioning structure 5 orients anchoring assembly 30 substantially orthogonal relative to base surface area 15 as is best illustrated in FIG. 1.

Anchoring assembly 30 may be further provided with electronic vertical sensing means disposed within housing 40 in the form of suitable electronic circuitry and sensors that are configured to perform a predetermined inflation control function that senses, and is dependent on, the vertical orientation of the anchoring assembly with respect to the surface upon which base surface area 15 is disposed.

The predetermined control function may comprise sensing a vertical orientation of anchoring assembly 30 or metering or controlling an inflation function of positioning structure 5 or both.

Anchor system 1 may further comprise a load sensor element 55 configured to perform a predetermined actuator control function based upon a load sensed by a load arm 60.

The predetermined actuator control function may comprise suitable electronic circuitry and sensors configured for sensing and determining the depth of penetration of anchor 35 into a surface and for enabling or disabling drive power to actuator 50 once anchor 35 reaches a predetermined depth below the surface of which it is penetrating.

Anchor system 1 may further comprise a tether 65 affixed to system 1 that may be used by a user to connect any selected element such as an unattended ground sensor element or antennal mast thereto whereby the selected element is tethered to anchor system 1 which, in turn, is fixedly anchored to a surface.

As depicted in FIG. 3, anchor system 1 may further comprise a separable, clamshell-like enclosure 70 that is configured to enclose and confine system 1 in a pre-inflated state prior to launch or deployment and to separate and release system 1 during an inflation of positioning structure 5.

The described anchor system 1 may be launched or dropped to its deployment location while folded and encapsulated in enclosure 70. Enclosure 70 is preferably fabricated from a thin lightweight waterproof material such as a plastic sheet material of suitable mechanical properties.

When in place at a desired location, positioning element 5 inflates using, for instance, compressed air means provided in anchoring assembly 30 and which inflation is initiated, for instance, by using suitable electronic timing and control circuitry provided within housing 40.

During an inflation of positioning structure 5, enclosure 70 is configured to separate or breaks open. Positioning structure 5 continues inflating to a toroidal donut-shape; holding anchoring assembly 30 in a vertical orientation. The chain of weights or weighting elements 20 around the perimeter of positioning structure 5 serves to maintain the correct orientation of positioning structure 5; i.e., maintaining the pointed end of anchor 35 oriented downwardly toward the ground upon completion of the inflation process.

The volume of housing 40 comprises actuator 50; a preferred embodiment comprising an electronic voice coil element. The stationary portion of the voice coil may be fixedly attached to housing 40 and the movable oscillating portion of the voice coil affixed to hammer element 45 which may comprise a heavy, metal cylindrical body of suitable mechanical properties and mass for the desired application.

Hammer element 45 is slideably disposed so as to permit oscillating movement upwardly and downwardly within the volume of housing 40. Grooves around hammer element 40 (i.e., breathers) may be provided to permit air to flow from top to bottom so the oscillation of hammer element 40 within the volume is not impeded by air compression.

A sealed compartment above the top dead center of the stroke of hammer element 40 may be provided to house suitable control electronics, sensors, battery and compressed air volume for inflating positioning element 5 or any combination of these elements.

In an alternative embodiment, a hinged load sensor 55 having an outwardly depending load arm 60 may be provided, as is depicted in FIGS. 2A-2C.

In the embodiment of FIGS. 2A-2C, prior to inflation, load arm 60 is folded and disposed within enclosure 70. Upon inflation of positioning structure 5 and after anchoring assembly 30 is released from enclosure 70, spring-loaded arm 60 swings to approximately a horizontal position. In this embodiment, load sensor 55 and suitable load sensor electronic circuitry are provided such that load arm 60 senses an upward force when applied by load arm 60 on anchor assembly 30.

After inflation and when the orientation of anchoring assembly 30 is approximately vertical, or as the vertical orientation may be sensed by an onboard vertical sensor, actuator 50 initiates the anchor hammering operation.

Actuator 50 is driven by an electrical drive signal configured to alternately apply an upward force that “lifts” the cylindrical hammer element 45 to the top of its stroke and then drives downwardly it to strike the upper surface of anchor 35 at a predetermined drive frequency.

A retaining sleeve in positioning structure 5 may be configured to releaseably retain anchoring assembly 30 by friction fit or adhesive or both so that when anchor 35 is driven into a surface by the oscillating hammer element 45 as driven by actuator 50, anchor assembly 30 is urged out the sleeve and becomes anchored and self-supporting.

When the hammering cycle is substantially complete, load arm 60 comes in contact with the surface of the ground. Load arm 60 is preferably configured to sense a predetermined proof-load for the system 1 of the invention. The proof-load may be provided off-center to induce a twisting force on anchor 35 in order to improve the “grab” of anchor 35 in the ground.

When load sensor 55 senses a predetermined proof load value by means of load arm 60, a signal is sent to actuator control circuitry to terminate the hammering phase. System 1 may be provided with sensing circuitry configured to sense whether the predetermined proof load is maintained by the anchor for a predetermined amount of time, after which time, the system 1 is anchored and ready to operate.

A preferred embodiment of the invention may have the following specifications:

Total anchor system length—700 mm

Enclosure diameter—300 mm

Anchor length (stake)—340 mm

Anchor diameter—25 mm

Hammer weight—8 Kg

Available hammering stroke—25 mm

A preferred actuator in the form of an electronic voice coil for use in the above preferred embodiment of the invention may comprise a voice coil available from BEI Kimko Magnetics LA28-22-000A having the following specifications:

Peak force—260N

Stroke—11.4 mm

Mechanical time constant—1.2 ms

Voltage—42V

Nominal current—8.8 A

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

I claim:

1. An autonomous anchoring system comprising:
an inflatable positioning structure comprising a base perimeter defining a base surface area,
a weighting element disposed proximal along least a portion of the base perimeter,
an inflating element,
an anchoring assembly comprising an anchor, a housing, and a hammer element oscillatably disposed in a volume within the housing,
an actuator configured to urge the hammer in a first stroke direction and a second stroke direction in the volume, the anchor and hammer element configured whereby the oscillation of the hammer element within the volume in the second stroke direction urges the anchor in the second stroke direction.

2. The system of claim 1 where the positioning structure and the anchoring assembly are configured whereby an inflation of the positioning structure orients the anchoring assembly substantially orthogonal relative to the base surface area.

3. The system of claim 1 wherein the actuator is an electronic voice coil.

4. The system of claim 1 wherein the anchoring assembly further comprises electronic vertical sensing means configured to perform a predetermined inflation control function that is dependent on a vertical orientation of the anchoring assembly.

5. The system of claim 1 further comprising a load sensing element configured to perform a predetermined actuator control function based upon a load sensed by a load arm.

6. The system of claim 1 further comprising a tether affixed to the system.

7. The system of claim 1 further comprising a separable enclosure configured to enclose and confine the system in a pre-inflated state and to separate and release the system during an inflation of the positioning structure.

8. An anchoring assembly comprising:
an anchor,
a housing,
a hammer element oscillatably disposed in a volume within the housing,
an actuator configured to urge the hammer in a first stroke direction and a second stroke direction in the volume,
the anchor and hammer element configured whereby the oscillation of the hammer element within the volume in the second stroke direction urges the anchor in the second stroke direction,
a load sensing element configured to perform a predetermined actuator control function based upon a load sensed by a load arm,

9. The system of claim 8 wherein the actuator is an electronic voice coil.
